(19) United States
(12) Patent Application Publication
(10) Pub. No.: US 2020/0277062 A1
(43) Pub. Date: Sep. 3, 2020

(54) AIRCRAFT HAVING HYBRID-ELECTRIC PROPULSION SYSTEM WITH ELECTRIC STORAGE LOCATED IN WINGS

(71) Applicant: Pratt & Whitney Canada Corp., Longueuil (CA)

(72) Inventors: Frank Becker, Saint Lambert (CA); Xi Wang, Montreal (CA); Antonio Pizzi, Verdun (CA); Charles E. Lents, Amston, CT (US)

(21) Appl. No.: 16/709,051

(22) Filed: Dec. 10, 2019

Related U.S. Application Data
(60) Provisional application No. 62/812,777, filed on Mar. 1, 2019.

(51) Int. Cl. B64D 27/02; B64D 27/10; B64D 27/24; B64D 29/02; B64D 41/00; B64D 37/04; B64D 31/02; B64C 3/32; B64C 3/34; B60L 50/60; B60L 15/20

(52) U.S. Cl. CPC B64D 27/02; B64D 27/10; B64D 27/24; B64D 29/02; B64D 41/00; B64D 37/04; B60L 2200/10; B64C 3/32; B64C 3/34; B60L 50/66; B60L 15/20; B64D 2027/026; B64D 2221/00; B64D 31/02

(57) ABSTRACT

An aircraft includes a fuselage defining a longitudinal axis between a forward end and an aft end. At least one airfoil is laterally extending from the fuselage defining an airfoil axis. An electrical system has an electric storage. The electric storage is positioned within the airfoil.

### CROSS REFERENCE TO RELATED APPLICATIONS

This application claims the benefit of and priority to U.S. Provisional Patent Application No. 62/812,777, filed Mar. 1, 2019, the disclosure of which is hereby incorporated by reference in its entirety.

### BACKGROUND OF THE INVENTION

### 1. Field of the Invention

The present disclosure relates to an aircraft having a hybrid-electric propulsion system, and more particularly, to an aircraft having a hybrid-electric propulsion system with batteries that are located in the wings of the aircraft.

### 2. Description of Related Art

Aircraft engines vary in efficiency and function over a plurality of parameters, such as thrust requirements, air temperature, air speed, altitude, and the like. Aircraft require the most thrust at take-off, wherein the demand for engine power is the heaviest. However, during the remainder of the mission, the aircraft engines often do not require as much thrust as during take-off. The size and weight of the engines allows them to produce the power needed for take-off, however after take-off the engines are in effect over-sized for the relatively low power required to produce thrust for cruising in level flight.

The conventional techniques have been considered satisfactory for their intended purpose. However, there is an ever present need for improved aircraft engines. This disclosure provides a solution for this need.

### SUMMARY

An aircraft includes a fuselage defining a longitudinal axis between a forward end and an aft end. At least one airfoil is laterally extending from the fuselage defining an airfoil axis. An electrical system has an electric storage. The electric storage is positioned within the airfoil.

In accordance with some embodiments, the aircraft includes a hybrid-electric propulsion system. The electrical system can be part of the hybrid-electric propulsion system. The hybrid-electric propulsion system can include a heat engine, and/or an electric-motor. The electrical system and electric storage can be operatively connected to the electric-motor for receiving power therefrom or for supplying power thereto. The electrical system can be electrically coupled to the electric-motor by way of a 1000-volt power bus. The electrical system can be electrically coupled to the electric-motor by way of a high voltage power bus. The aircraft can include a nacelle mounted to the airfoil. The electric storage can be positioned inboard of and/or outboard of the nacelle. The heat engine and the electric-motor can be positioned within the nacelle.

In some embodiments, the aircraft includes a liquid fuel tank. The liquid fuel tank can be positioned inboard of and/or outboard of the nacelle. The airfoil can include vent openings between an area outside of the airfoil and an electrical compartment in which the electric storage is positioned.

The electrical system can include an electric-motor controller. The airfoil can include an electrical compartment in which the electric-motor controller and electric storage are positioned. The airfoil can include an electrical compartment in which the electric storage is positioned. The electrical compartment can be made from a material that is fire proof and/or fire resistant, and/or can include a lining that is fire proof and/or fire resistant. In some embodiments, the electric storage includes at least one battery. In some embodiments, at least one battery includes a plurality of batteries. The airfoil can include an electrical compartment in which the plurality of batteries are stored. The electrical compartment can include sections configured and adapted to contain a respective portion of the plurality of batteries. Each section can be divided from adjacent sections by a wall that is fire proof and/or fire resistant.

In accordance with some embodiments, the at least one airfoil includes two airfoils extending from opposite sides of the fuselage. In some embodiments, each of the two airfoils includes a plurality of batteries and a liquid fuel tank. In some embodiments, a first of the two airfoils can include a plurality of batteries and a liquid fuel tank and a second of the airfoils can include two liquid fuel tanks. The aircraft can include a 28V aircraft power system connected to the hybrid-electric propulsion system for generating 28V of aircraft power supply for aircraft systems.

These and other features of the systems and methods of the subject disclosure will become more readily apparent to those skilled in the art from the following detailed description of the embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic depiction of a top plan view of an embodiment of an aircraft constructed in accordance with the present disclosure, showing batteries positioned within both of the airfoils extending from the aircraft;

FIG. 2 is a schematic depiction of a perspective view of a portion of the aircraft of FIG. 1, showing batteries positioned inboard of respective nacelles;

FIG. 3 is a schematic depiction of an embodiment of a hybrid-electric propulsion system constructed in accordance with the present invention, showing the batteries operatively connected to the electric-motor controller and electric-motor;

FIG. 4 is a schematic depiction of a bottom plan view of a portion of the aircraft of FIG. 1, showing a heat vent on an underside surface of an airfoil;

FIG. 5 is a schematic depiction of a perspective view of the electrical compartment of the aircraft of FIG. 1, showing batteries positioned within the compartment 120;

FIG. 6 is a schematic depiction of a top plan view of another embodiment of an aircraft constructed in accordance with the present disclosure, showing batteries positioned within both of the airfoils extending from the aircraft;

FIG. 7 is a schematic depiction of a perspective view of a portion of the aircraft of FIG. 6, showing batteries positioned outboard of respective nacelles;

FIG. 8 is a schematic depiction of a bottom plan view of a portion of the aircraft of FIG. 6, showing a heat vent on an underside surface of an airfoil;

FIG. 9 is a schematic depiction of a top plan view of an embodiment of an aircraft constructed in accordance with the present disclosure, showing batteries positioned within one of the airfoils extending from the aircraft;

FIG. 10 is a schematic depiction of a perspective view of a portion of the aircraft of FIG. 9, showing batteries positioned outboard of one of the nacelles;

FIG. 11 is a schematic depiction of a bottom plan view of a portion of the aircraft of FIG. 9, showing air scoops and a heat vent on an underside surface of one of the airfoils; and

FIG. 12 is a schematic depiction of a top plan view of another embodiment of an aircraft constructed in accordance with the present disclosure, showing batteries positioned inboard of the nacelle.

### DETAILED DESCRIPTION OF THE EMBODIMENTS

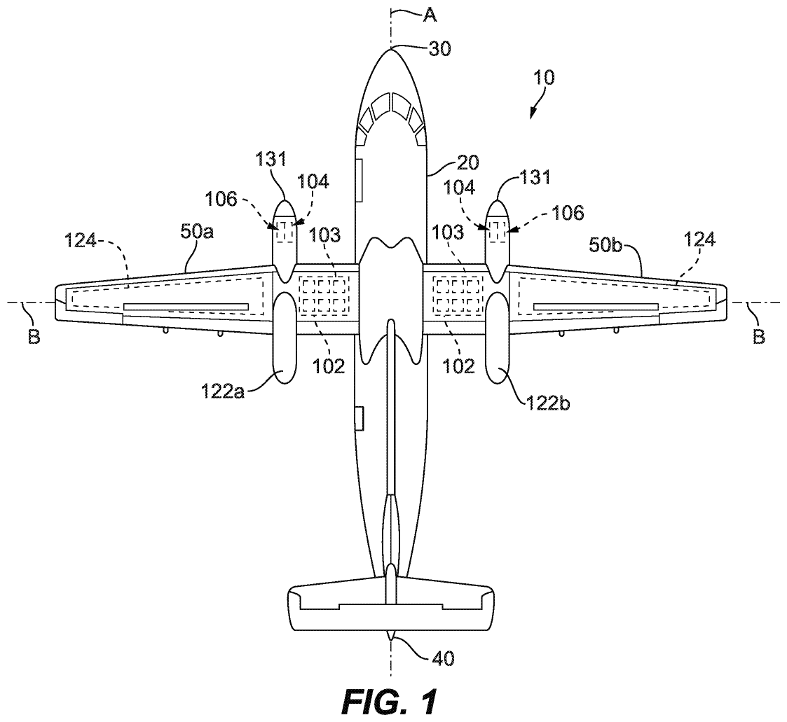

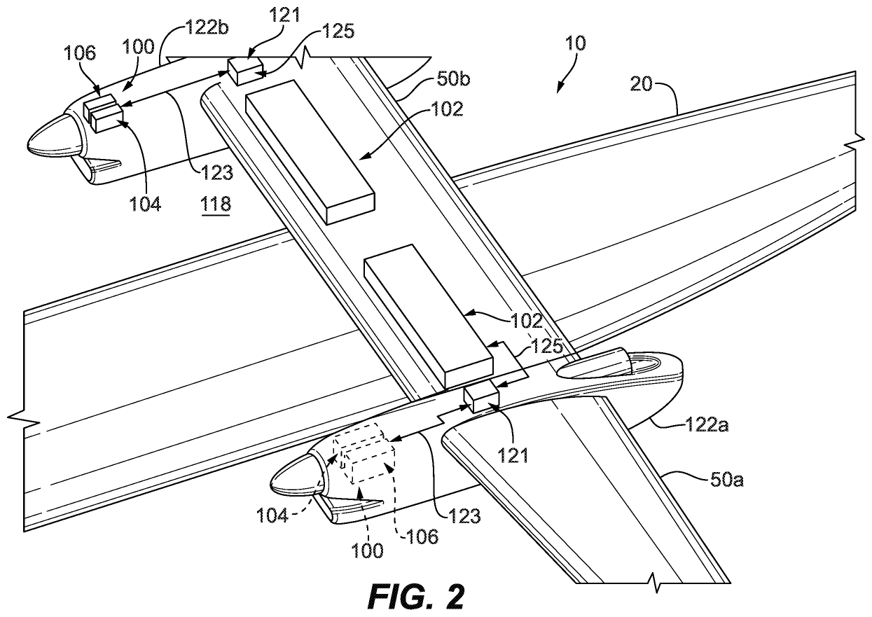

Reference will now be made to the drawings wherein like reference numerals identify similar structural features or aspects of the subject disclosure. For purposes of explanation and illustration, and not limitation, a partial view of an exemplary embodiment of an aircraft constructed in accordance with the present disclosure is shown in FIG. 1 and is designated generally by reference character 10. Other embodiments of aircraft 10 in accordance with the disclosure, or aspects thereof, are provided in FIGS. 2-12, as will be described. The systems and methods described herein can be used to provide hybrid propulsion, e.g., for improving fuel efficiency in aircraft. Moreover, embodiments described herein can readily apply to all-electric aircraft, or the like.

As shown in FIGS. 1-3, an aircraft 10 includes a fuselage 20 defining a longitudinal axis A between a forward end 30 and an aft end 40. Airfoils 50a and 50b laterally extend from the fuselage 20 and each define a respective airfoil axis B. Each airfoil 50a and 50b includes a respective nacelle 122a and 122b mounted to thereto. The aircraft 10 includes hybrid-electric propulsion systems 100, portions of which are disposed in each nacelle 122a and 122b. An electrical system 101 is part of each hybrid-electric propulsion system 100. Each hybrid-electric propulsion system 100 includes a heat engine 104, e.g. a thermal engine, and an electric-motor 106, which on their own or together drive an air mover 105, e.g. a propeller, fan or the like, by way of a reduction gear box 107 and shaft 111. Each nacelle 122a and 122b includes a respective heat engine 104 and an electric-motor 106. Air movers 105 are not shown in FIG. 1, but it is contemplated that each nacelle 122a and 122b would include a respective air mover 105 mounted on their forward facing hubs 131. Each reduction gear box 107 has an input 109a for heat engine 104 and an input 109b for electric-motor 106. Those skilled in the art will also readily appreciate that a clutch can be disposed between each reduction gear box 107 and its respective heat engine 104 and another clutch can be disposed between each electric-motor 106 and its respective reduction gear box 107.

It is contemplated that heat engine 104 (and heat engines 204 and 304, described below) could be a heat engine of any type, e.g., a gas turbine, spark ignited, diesel, rotary or reciprocating engine of any fuel type and with any configuration of turbomachiney elements, either turbocharger, turbosupercharger, supercharger and exhaust recovery turbo compounding, either mechanically, electrically, hydraulically or pneumatically driven.

With continued reference to FIGS. 1-3, each electrical system 101 includes an electric storage 103 that includes a battery bank, or the like. In the embodiment of FIGS. 1-3, each storage 103 is made up of a plurality of batteries 102. Batteries 102 can be rechargeable batteries. Sets of batteries 102 are positioned on both airfoil 50a and airfoil 50b inboard of respective nacelles 122a and 122b. Each airfoil 50a and 50b also includes a liquid fuel tank 124. The positioning of the respective sets of batteries 102 and the fuel tanks 124 in each of the two airfoils 50a and 50b is symmetrical across the longitudinal axis A. Each liquid fuel tank 124 is operatively connected to one or more of heat engines 104 to provide fuel thereto. A fuel control system, e.g. fuel system 133, is disposed between one or more liquid fuel tanks 124 and heat engines 104 to control fuel distribution from one or more fuel tanks 124 to heat engines 104 (regardless of position of the tank 124 on airfoil 50a or 50b). Each liquid fuel tank 124 is positioned outboard from their respective nacelles 122a and 122b. Each hybrid-electric propulsion system 100 is operatively connected to a 28V aircraft power system 135 to supply 28V power for aircraft systems, e.g. computer systems and the like. Aircraft power system 135 can include one more rectifiers, batteries, and/or distribution systems contained therein. Those skilled in the art will readily appreciate that aircraft power system 135 can provide power to a variety of aircraft electronics systems that run on standard aircraft voltage, e.g. 28V, via output 139.

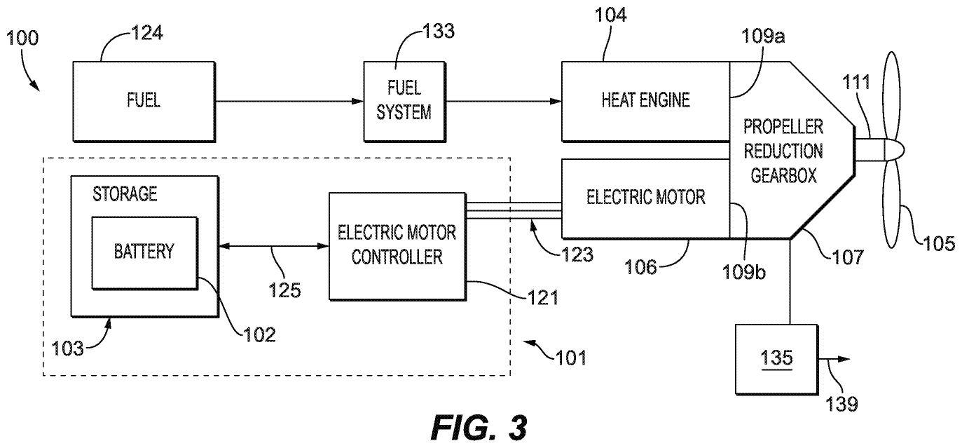

As shown in FIGS. 2-3, the storage 103 (and the associated batteries 102) are operatively connected to a respective electric-motor 106 for receiving power therefrom or for supplying power thereto by way of an electric-motor controller 121. It is contemplated that an electrical distribution system or battery management system can be positioned within the storage 103, or between storage 103 and the electric-motor controller 121. The electrical distribution system and/or battery management system is configured for managing the electrical power from the power storage 103, e.g. the batteries 102, to the electric-motor 106. Each electric-motor controller 121 is positioned within a respective one of nacelles 122a and 122b.

In some embodiments, it is contemplated that the electric-motor controllers 121 can be positioned within the fuselage 20 or an electrical compartment 120, as described below, or any suitable location within aircraft 10. As shown in FIGS. 2-3, each electrical system, e.g. the electric-motor controller 121 and the storage 103, is electrically coupled to a given electric-motor 106 by way of a high voltage power bus 123. High voltage power bus 123 can be for 500 V or greater, e.g. a range from 890-1000 V, or higher. The high voltage power bus 123 is bi-directional, meaning power can go to electric-motor 106 from electric-motor controller 121 and from electric-motor 106 to electric-motor controller 121. Each power storage 103, e.g. each group of batteries 102, is operatively connected to its respective electric-motor controller 121 by a respective conductor 125.

With continued reference to FIGS. 2-3, those skilled in the art will also readily appreciate that hybrid-electric propulsion system 100 can include a motor drive positioned in between the electric-motor controller 121 and the electric-motor 106. The motor drive is configured for controlling, for instance, a rotational speed of the electric-motor 106. It is also contemplated that each set of batteries 102, e.g. the set on airfoil 50a and the set on airfoil 50b, is connected to one or more inverter/rectifier components (for example, positioned between each storage 103 and its respective electric-motor 106) for supplying power from each storage 103 to drive the respective electric-motor 106, or, in an energy recovery mode, to store into each storage 103 energy generated by driving each electric-motor 106 in a generator mode.

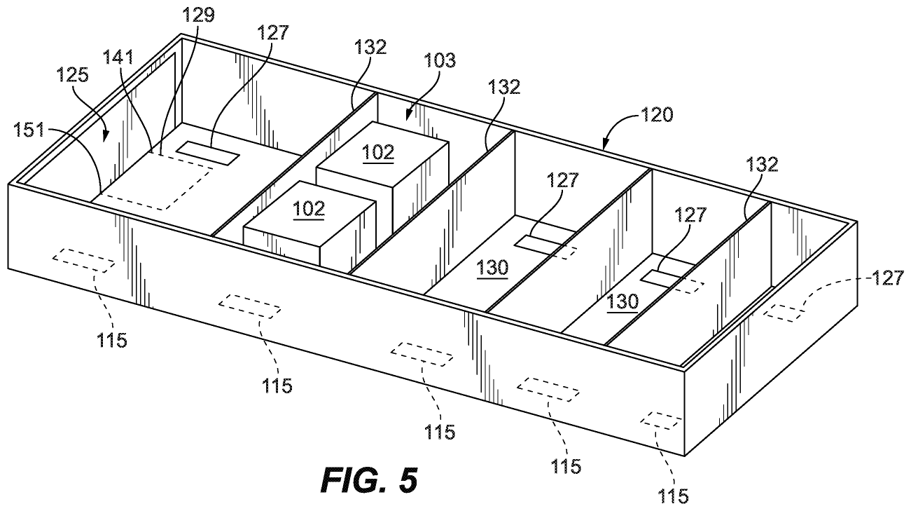

As shown in FIG. 5, it is also contemplated that compartment 120 can include a liquid cooling circuit 129 (schematically shown by broken-lined arrows in FIG. 5) to assist in on-ground cooling, for example. Liquid cooling circuit 129 includes an input 141 and an output 151. The liquid cooling circuit can be connected to a ground cart that includes the remaining portions of the cooling system (e.g. pump, coolant, etc.) or it can be contained within aircraft 10. If contained in aircraft 10, various coolant system components, such as a radiator, heat exchanger or the like, may be included.

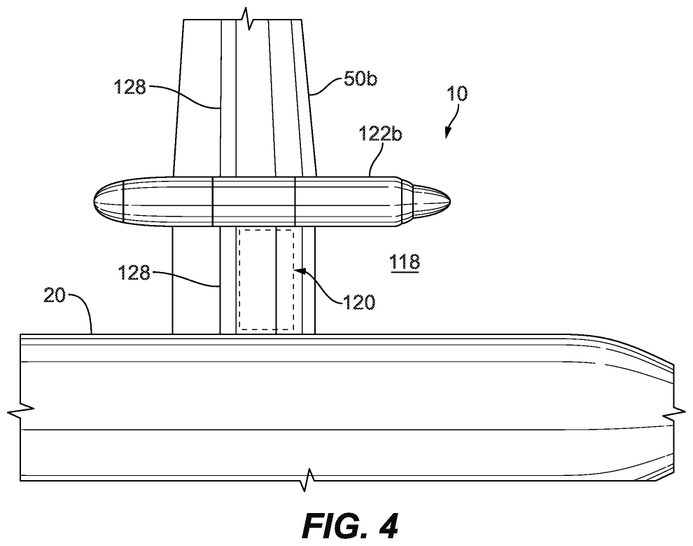

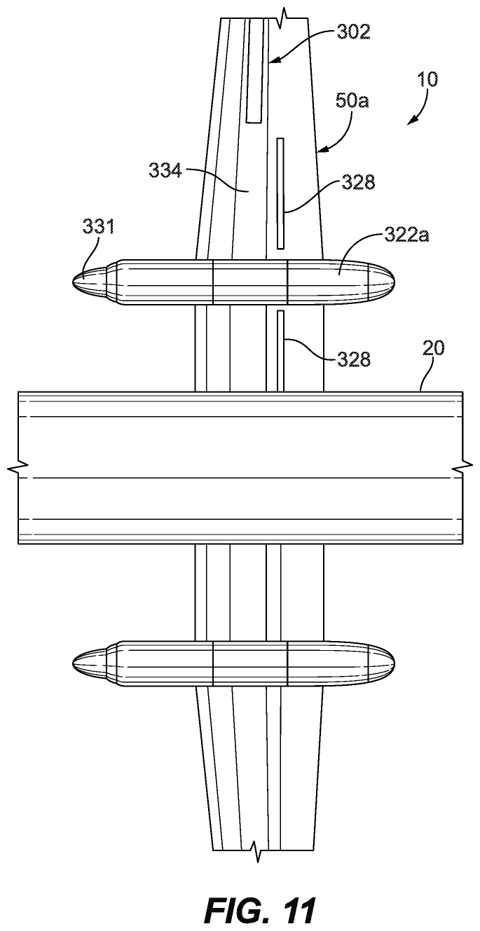

With reference now to FIGS. 3-4, each airfoil 50a and 50b includes vent openings 128, e.g. heat vent outlets 128, that are in fluid communication with openings 115 and/or 127 of respective compartments 120 between the area 118 outside of the airfoil and the electrical compartment 120 in which the batteries 102 are positioned. While FIG. 11 shows vent openings 128 both inboard and outboard of nacelle 122b, it is contemplated that vent openings 128 can be included either inboard or outboard, depending on the position of batteries 102. Moreover, while not shown, it is contemplated that airfoil 50a also includes vent openings similar to those shown on airfoil 50b to allow venting from electrical compartment 120 positioned thereon. Vent openings 128 allow heat, fumes, or the like to be dissipated from the electrical storage 103, e.g. the group of batteries 102, in compartment 120. Vent openings 128 (and/or corresponding openings 115 and/or 127, described below) can include fire detection and/or extinguishing methods and systems. It is also contemplated that heat dissipated from electrical storage 103 can be used for anti-ice or de-icing of airfoils 50a and 50b, or other components, or general heating of the aircraft 10 and its components (e.g. cabin, etc.). The heat can be directed to a given area for anti-ice/de-ice or heating as needed, directly, by way of heat exchanger, or the like (this readily applies to heat from electrical storages 203 and 303, described below).

As shown in FIG. 5, each electrical compartment 120 is configured to hold electrical storage 103. Each electrical compartment 120 includes a fire proof and/or resistant lining 125. It is also contemplated that in lieu of or in addition to the lining 125, each compartment 120 can be made from a fire proof and/or fire resistant material, or be constructed in another suitable fire resistant and/or proof configuration. In the embodiment of FIG. 5, electrical storage 103 is a plurality of batteries 102. For sake of clarity, only some of batteries 102 are shown. In some embodiments, a given electric-motor controller 121 can be positioned within a respective electrical compartment 120. Each electrical compartment 120 includes sections 130 configured and adapted to contain a respective portion of the plurality of batteries 102. Each section is divided from adjacent sections 130 by a fire proof and/or resistant wall 132. Electrical compartment 120 includes openings 115 and/or 127 for venting.

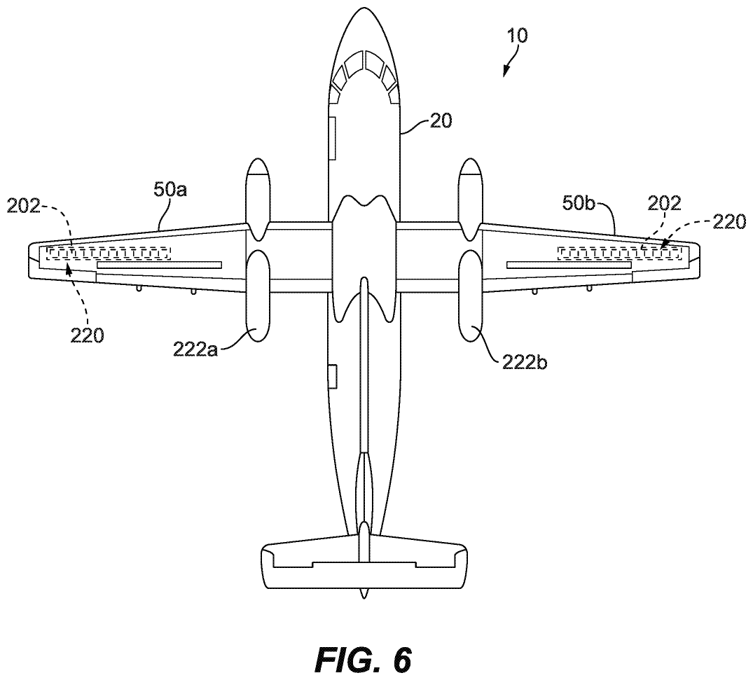

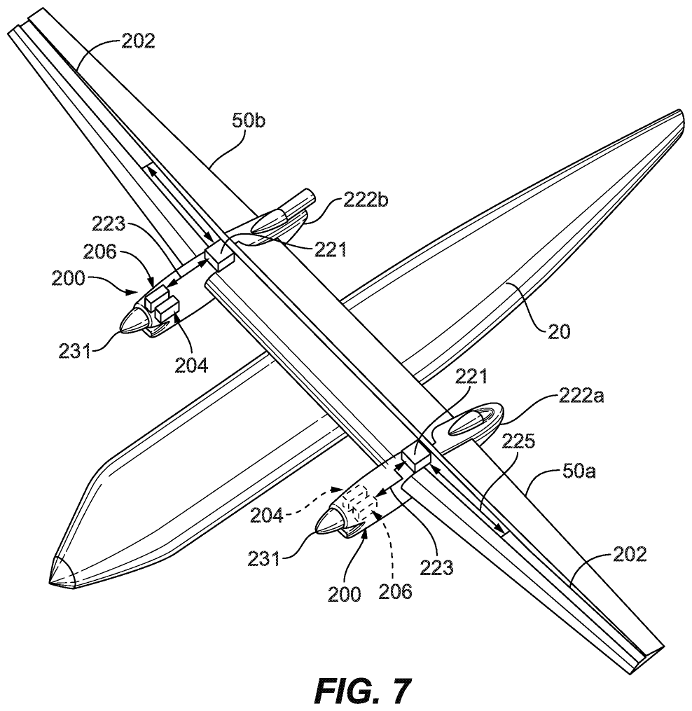

As shown in FIGS. 6-7, an aircraft 10 includes a fuselage 20 defining a longitudinal axis A between a forward end 30 and an aft end 40. Airfoils 50a and 50b laterally extend from the fuselage 20 and each define a respective airfoil axis B. Each airfoil 50a and 50b includes a respective nacelle 222a and 222b mounted to thereto. The aircraft 10 includes hybrid-electric propulsion systems 200, portions of which are disposed in each nacelle 222a and 222b. An electrical system, not shown, is very similar to electrical system 101, and is part of each hybrid-electric propulsion system 200. The description of electrical system 101 readily applies to the electrical system of electric propulsion system 200. Hybrid-electric propulsion system 200 and the operation thereof is very similar to system 100 described above except for the position of batteries 202 with respect to the nacelles 222a and 222b. As such, the description provided above for system 100 readily applies to system 200. Each hybrid-electric propulsion system 200 includes a heat engine 204, e.g. a thermal engine, and an electric-motor 206, which on their own or together drive an air mover, e.g. a air mover 105, by way of a reduction gear box, e.g. reduction gearbox 107, and a shaft, e.g. shaft 111. Each nacelle 222a and 222b includes a respective heat engine 204 and an electric-motor 206. It is contemplated that each nacelle 222a and 222b would include a respective air mover, similar to air mover 105 described above, mounted on their forward facing nacelle hubs 231. Each reduction gear box has inputs similar to inputs 109a and 109b, described above. Those skilled in the art will also readily appreciate that hybrid-electric propulsion system 200 includes one or more clutches, similar to those describe above relative to system 100.

With continued reference to FIGS. 6-8, each electrical system includes an electric storage 203 that includes a battery bank, or the like. In the embodiment of FIGS. 6-8, the storage 203 is made up of a plurality of batteries 202, similar to batteries 102 and storage 103 described above. The electrical system of FIGS. 6-8 is the same as electrical system 101 except that batteries 202 are positioned on both airfoil 50a and airfoil 50b outboard of respective nacelles 222a and 222b. Each airfoil 50a and 50b also includes a liquid fuel tank 224. Each liquid fuel tank 224 is operatively connected to one or more of heat engines 204 to provide fuel thereto. A fuel control system, e.g. fuel system 133, is disposed between one or more liquid fuel tanks 224 and heat engines 204 to control fuel distribution from one or more fuel tanks 224 to heat engines 204 (regardless of position of the tank 224 on airfoil 50a or 50b). Each liquid fuel tank 224 is positioned inboard from a respective nacelle 222a or 222b. Each hybrid-electric propulsion system 200 is similar to system 100 in that they are both operatively connected to a 28V aircraft power system, e.g. power system 135, to supply 28V power. The aircraft power system connected to system 200, and the function thereof, is similar to aircraft power system 135 described above such that the description thereof readily applies to system 200.

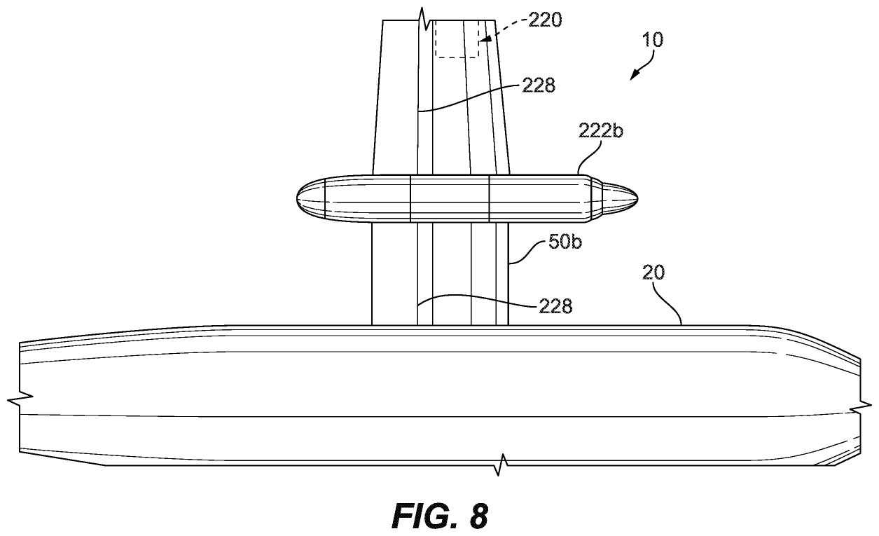

As shown in FIGS. 7-8, the storage 203, e.g. batteries 202, are operatively connected to a respective electric-motor 206 for receiving power therefrom or for supplying power thereto by way of an electric-motor controller 221, similar to electric-motor 106 and batteries 102, described above. Each electric-motor controller 221 is positioned within a respective one of nacelles 222a and 222b. In some embodiments, it is contemplated that the electric-motor controllers 221 can be positioned within the fuselage 20 or a respective electrical compartment 220, as described above with respect to electric-motor controllers 121. Each electrical compartment 220 is the same as that of 120 as shown in FIG. 5, except its position relative to the nacelles, e.g. nacelles 222a and 222b is different. The electrical system, e.g. the electric-motor controller 221 and the storage 203, is electrically coupled to each electric-motor 206 by way of a high voltage power bus 223. High voltage power bus 223 can be for 500 V or greater, e.g. a range from 890-1000 V, or higher. It is also contemplated that each set of batteries 202, e.g. the set on airfoil 50a and the set on airfoil 50b, is connected to one or more inverter/rectifier components, similar to those described above relative to each storage 103 and their respective electric-motor 106. The power storage 203 is operatively connected to the electric-motor controller 221 by conductors 225. It is also contemplated that compartment 220 can include a liquid cooling circuit to assist in on-ground cooling, for example. The liquid cooling circuit in compartment 220 is similar to the liquid cooling circuit 129 described above relative to compartment 120.

With reference now to FIG. 8, each airfoil 50a and 50b includes vent openings 228, e.g. heat vent outlets 228, that are in fluid communication with openings, similar to openings 115 and 127, of respective compartments 220 between the area 218 outside of the airfoil and the electrical compartment 220 in which the batteries 202 are positioned. While FIG. 8 shows vent openings 228 both inboard and outboard of nacelle 222b, it is contemplated that vent openings 228 can also be included either inboard or outboard, depending on the position of batteries 202. Moreover, while not shown, it is contemplated that airfoil 50a also includes vent openings 228 similar to those shown on airfoil 50b to allow venting from electrical compartment 220 positioned thereon. Vent openings 228 function similarly to vent openings 128, as described above. Each electrical compartment 220 includes openings, e.g. openings 115 and 127, and fire proof and/or resistant features, e.g. a lining and walls, similar to those of compartment 120. Vent openings 228 and/or corresponding compartment 120 openings can include fire detection and/or extinguishing methods and systems.

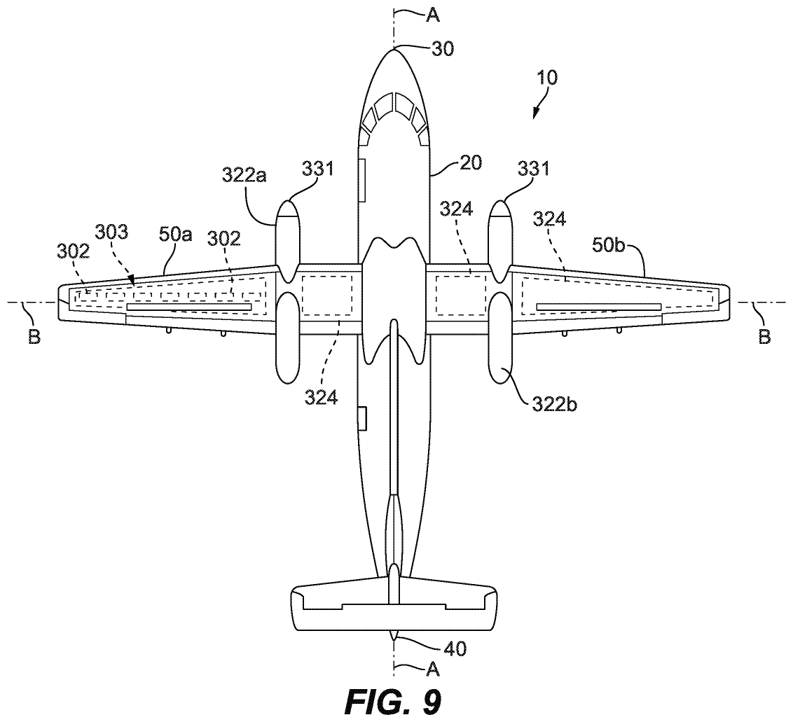

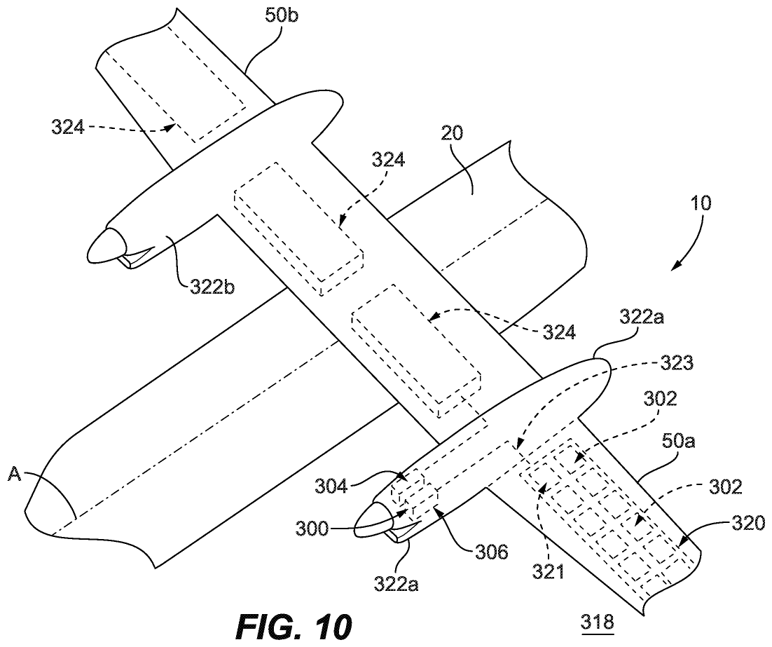

As shown in FIGS. 9-10, an aircraft 10 includes a fuselage 20 defining a longitudinal axis A between a forward end 30 and an aft end 40. Airfoils 50a and 50b laterally extend from the fuselage 20 and are similar to airfoils 50a and 50b of FIG. 1. Each airfoil 50a and 50b includes a respective nacelle 322a and 322b mounted to thereto. The aircraft 10 includes a hybrid-electric propulsion system 300, very similar to hybrid-electric propulsion system 100, portions of which are disposed in first nacelle 322a. An electrical system, similar to electrical system 101, is part of the hybrid-electric propulsion system 300. The description above relative to electrical system 101 readily applies to the electrical system of hybrid-electric propulsion system 300. The hybrid-electric propulsion system 300 is the same as hybrid-electric propulsion system 100 except that batteries 302 of system 300 are located outboard of a respective nacelle 322a. Air movers are not shown in FIGS. 9-10, but it is contemplated that each nacelle 322a and 322b would include a respective air mover, similar to air mover 105, mounted on their forward facing hubs 331. Hybrid-electric propulsion system 300 includes a reduction gear box, similar to reduction gear box 107, having similar inputs as reduction gearbox 107. Hybrid-electric propulsion system 300 includes at least one clutch similar to those described above with respect to system 100.

With continued reference to FIGS. 9-10, the electrical system, similar to system 101, includes an electric storage 303 that includes a battery bank, or the like. In the embodiment of FIGS. 9-11 the storage 303 is made up of a plurality of batteries 302, similar to batteries 102 described above. Batteries 302 are positioned on airfoil 50a and airfoil 50a also includes a liquid fuel tank 324. One or more liquid fuel tanks 324 are operatively connected to heat engine 104 to provide fuel thereto. A fuel control system, similar to fuel system 133 described above, is disposed between one or more liquid fuel tanks 324 and heat engine 304 to control fuel distribution from one or more fuel tanks 324 to heat engine 304 (regardless of position of the tank 124 on airfoil 50a or 50b). Unlike the embodiments of FIGS. 1-8, instead of having batteries 302 on the other airfoil 50b, only liquid fuel tanks 324 are included on airfoil 50b. Moreover, it is also contemplated that nacelle 322b includes a turbine engine, instead of a hybrid-electric propulsion system 300. However, those skilled in the art will readily appreciate that another hybrid-electric propulsion system, like that of system 100, can be used on airfoil 50b and nacelle 122b. Hybrid-electric propulsion system 300 is operatively connected to a 28V aircraft power system, similar to system 135 described above.

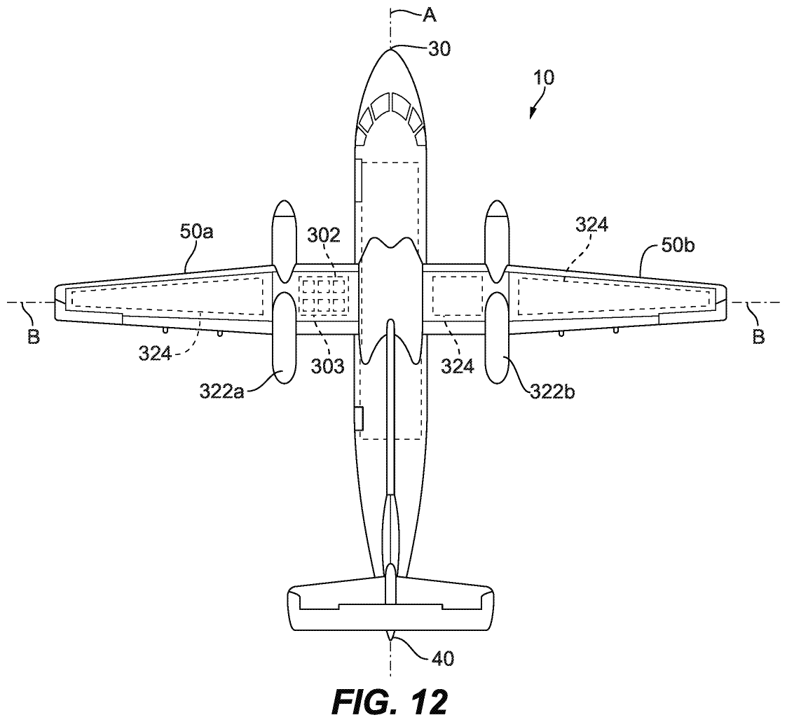

With reference now to FIGS. 10-11, the heat engine 304 and the electric-motor 306 are positioned within the nacelle 322a. The batteries 302 are shown positioned outboard of the nacelle 322a. However, it is also contemplated that in some embodiments, the batteries are positioned inboard of the nacelle 322a (e.g. as shown in FIG. 12). The liquid fuel tank 324 on airfoil 50a is positioned inboard of the nacelle 322a. However, it is also contemplated that in some embodiments the liquid fuel tank 324 can be positioned outboard of nacelle 322a, for example, when batteries 302 are positioned inboard of nacelle 322a (as shown in FIG. 12).

As shown in FIGS. 10-11, the batteries 302 are operatively connected to the electric-motor 306 for receiving power therefrom or for supplying power thereto by way of an electric-motor controller 321. The electrical system 301, e.g. the electric-motor controller 321 and the storage 303, is electrically coupled to the electric-motor 306 by way of a high voltage power bus 323. High voltage power bus 323 can be for 500 V or greater, e.g. a range from 890-1000 V, or higher. It is also contemplated that batteries 302 are connected to one or more inverter/rectifier components, similar to those described above for batteries 102 and 202.

As shown in FIG. 11, the airfoil 50a includes vent openings 328, similar to vent openings 128 and/or 228, which can be in fluid communication with openings of compartment 320 between the area 318 outside of the airfoil and the electrical compartment 320 in which the batteries 302 are positioned. While FIG. 11 shows vent openings 328 both inboard and outboard of nacelle 322a, it is contemplated that vent openings 328 can also be included either inboard or outboard, depending on the position of batteries 302. Vent openings 328 and/or corresponding openings in compartment 320 can include fire detection and/or extinguishing methods and systems. Vent openings 228 function similarly to vent openings 128, as described above. It is also contemplated that compartment 320 can include a liquid cooling circuit to assist in on-ground cooling, for example. The liquid cooling circuit in compartment 320 is similar to the liquid cooling circuit 129 described above relative to compartment 120.

With continued reference to FIGS. 9-11, the electrical compartment 320 includes openings, e.g. openings 115 and 127, and fire proof and/or resistant features/configurations, e.g. materials, a lining and/or walls, similar to those of compartment 120. While electric-motor controller 321 is shown positioned in electrical compartment 320, those skilled in the art will readily appreciate that electric-motor controller 321 can be positioned within the fuselage 20 or within the nacelle 322a, as described above in FIGS. 1-9.

As shown in FIG. 12, an alternative embodiment of aircraft 10 is shown. Aircraft 10 of FIG. 12 is the same as aircraft 10 of FIG. 9, except that the batteries 302 are positioned inboard of the nacelle 322a and the liquid fuel tank 324 on airfoil 50a is positioned outboard of nacelle 322a. Airfoil 50b includes liquid fuel tanks 324 without any electric storage 103 and nacelle 322b of airfoil 50b can include a gas turbine engine, for example. Similar to the embodiment of FIG. 9, those skilled in the art will readily appreciate that while the combination of batteries 302 and fuel tank 324 are only shown on airfoil 50a, a similar hybrid-electric propulsion system 300, and the associated batteries 302 and fuel tank 324 could be used on airfoil 50b such that both propulsion systems on the aircraft 10 are hybrid-electric.

The methods and systems of the present disclosure, as described above and shown in the drawings provide for hybrid-electric and/or electric propulsion systems with superior properties including improved energy storage and use of hybrid heat engine and electric-motor power. While the apparatus and methods of the subject disclosure have been shown and described with reference to certain embodiments, those skilled in the art will readily appreciate that change and/or modifications may be made thereto without departing from the scope of the subject disclosure.

What is claimed is:

1. An aircraft comprising:
a fuselage defining a longitudinal axis between a forward end and an aft end;
at least one airfoil laterally extending from the fuselage defining an airfoil axis;
an electrical system having an electric storage, wherein the electric storage is positioned within the airfoil.

2. The aircraft as recited in claim 1, further comprising a hybrid-electric propulsion system, wherein the electrical system is part of the hybrid-electric propulsion system, wherein the hybrid-electric propulsion system includes a heat engine.

3. The aircraft as recited in claim 2, wherein the hybrid-electric propulsion system includes an electric-motor, wherein the electrical system is electrically coupled to the electric-motor by way of a 1000-volt power bus.

4. The aircraft as recited in claim 2, wherein the hybrid-electric propulsion system includes an electric-motor, wherein the electrical system is electrically coupled to the electric-motor by way of a high voltage power bus.

5. The aircraft as recited in claim 2, wherein the hybrid-electric propulsion system includes an electric-motor, wherein the electric system and electric storage are operatively connected to the electric-motor for receiving power therefrom or for supplying power thereto.

6. The aircraft as recited in claim 1, wherein the aircraft includes a nacelle mounted to the airfoil.

7. The aircraft as recited in claim 6, wherein the electric storage is positioned at least one of inboard of or outboard of the nacelle.

8. The aircraft as recited in claim 6, further comprising a hybrid-electric propulsion system, wherein the electrical system is part of the hybrid-electric propulsion system, wherein the hybrid-electric propulsion system includes a heat engine and an electric-motor, wherein the electric storage is operatively connected to the electric-motor for receiving power therefrom or for supplying power thereto, and wherein the heat engine and the electric-motor are positioned within the nacelle.

9. The aircraft as recited in claim 6, further comprising a liquid fuel tank, wherein the liquid fuel tank is positioned at least one of inboard of or outboard of the nacelle.

10. The aircraft as recited in claim 1, wherein the airfoil includes vent openings between an area outside of the airfoil and an electrical compartment in which the electric storage is positioned.

11. The aircraft as recited in claim 1, wherein the electrical system includes an electric-motor controller, wherein the airfoil includes an electrical compartment in which the electric-motor controller and the electric storage are positioned.

12. The aircraft as recited in claim 1, wherein the airfoil includes an electrical compartment in which the electric storage is positioned, wherein the electrical compartment includes a lining that is at least one of fire proof or fire resistant lining.

13. The aircraft as recited in claim 1, wherein the airfoil includes an electrical compartment in which the electric storage is positioned, wherein the electrical compartment includes a material that is at least one of fire proof or fire resistant.

14. The aircraft as recited in claim 1, wherein the electric storage includes a plurality of batteries, wherein the airfoil includes an electrical compartment in which the plurality of batteries are stored.

15. The aircraft as recited in claim 14, wherein the electrical compartment includes sections configured and adapted to contain a respective portion of the plurality of batteries, wherein each section is divided from adjacent sections by a wall that is at least one of fire proof or fire resistant.

16. The aircraft as recited in claim 1, wherein the electric storage includes at least one battery.

17. The aircraft as recited in claim 1, wherein the at least one airfoil includes two airfoils extending from opposite sides of the fuselage, wherein each of the two airfoils includes a plurality of batteries and a liquid fuel tank.

18. The aircraft as recited in claim 17, wherein the positioning of the respective batteries and the fuel tanks in each of the two airfoils is symmetrical across the longitudinal axis.

19. The aircraft as recited in claim 1, wherein the at least one airfoil includes two airfoils extending from opposite sides of the fuselage, wherein a first of the two airfoils includes a plurality of batteries and a liquid fuel tank, wherein a second of the airfoils includes two liquid fuel tanks.

20. The aircraft as recited in claim 1, further comprising a hybrid-electric propulsion system, wherein the electrical system is part of the hybrid-electric propulsion system, wherein the hybrid-electric propulsion system includes a heat engine and an electric-motor, the aircraft further comprising a 28V aircraft power system connected to the hybrid-electric propulsion system for generating 28V of aircraft power supply for aircraft systems.
